(19) United States
(12) Patent Application Publication
(10) Pub. No.: US 2024/0208578 A1
(43) Pub. Date: Jun. 27, 2024

(54) Vehicle with a Movably Mounted Body

(71) Applicant: StreetScooter GmbH, Aachen (DE)

(72) Inventors: Jürgen SCHÜLLER, Aachen (DE); Sascha WEIßGERBER, Herzogenrath (DE); Anuja NAGLE, Aachen (DE); Katja DREBES, Aachen (DE)

(21) Appl. No.: 18/544,007

(22) Filed: Dec. 18, 2023

(30) Foreign Application Priority Data
Dec. 22, 2022 (DE) 102022134558.0

(51) Int. Cl. B62D 24/02

(52) U.S. Cl. CPC B62D 24/02

(57) ABSTRACT

A vehicle includes a vehicle frame and a body arranged on the vehicle frame, wherein the body is connected in a front region of the vehicle frame to the vehicle frame by means of at least one flexible connecting element, and the flexible connecting element is designed to ensure a movement of the body away from the vehicle frame in the vertical direction. This provides a connecting element which permits a movement of the body relative to the vehicle frame to compensate for torsional forces.

The invention relates to a vehicle comprising a vehicle frame and a body arranged on the vehicle frame.

Vehicles, in particular lorries or utility vehicles, generally consist of a basic chassis or a vehicle frame on which a body is arranged. “Body” refers to superstructures, such as a flatbed or a box body.

Conventionally, the body is firmly bolted to the vehicle frame to create a rigid system of the vehicle frame and body. Unlike the body, the vehicle frame often has a certain degree of inherent elasticity. This means that the vehicle frame slightly stretches or moves when traveling over bumps. The body on the vehicle frame, on the other hand, is connected to the vehicle frame rigidly and without any scope for movement.

If the vehicle is standing on or traveling over uneven ground, for example if the vehicle is parked with a tire on the curb, the partial oblique position produces torsional forces which act on the vehicle chassis and on the body. Torsion describes the twisting of a body arising because of the effect of a torsional moment. If the vehicle is now standing with a tire on a raised curb, the vehicle is twisted about the longitudinal axis. The longitudinal axis of the vehicle or of the vehicle frame and the longitudinal axis of the body are displaced relative to each other. However, since the body is rigidly connected to the vehicle frame without any possibility of compensating for said torsional forces, said torsional forces act on the connecting points between the body and the vehicle frame. This effect is particularly problematic in the event of rigid superstructures which do not have any inherent flexibility either. As a result, considerable stress is placed on the bolted connections of the body to the vehicle frame and considerable stress is placed on the rigid body itself.

This considerable stress in the event of torsional movements in a rigid system is associated with increased wear. The connecting points or the bolted connections are subject to increased forces, which reduces the durability of the connecting points between the vehicle frame and the body.

The devices or methods known from the prior art have not to date made it possible to provide a way of arranging the body movably on the vehicle frame in such a manner that torsional movements can be compensated for.

Taking this as the starting point, it is the object of the invention to provide a connecting element that allows a movement of the body relative to the vehicle chassis in order to compensate for torsional forces.

This object is achieved by the subject matter of claim 1. Preferred developments are found in the dependent claims.

According to the invention, a vehicle is thus provided comprising a vehicle frame and a body arranged on the vehicle frame, wherein the body is connected in a front region of the vehicle frame to the vehicle frame by means of at least one flexible connecting element, and the flexible connecting element is designed to ensure a movement of the body away from the vehicle frame in the vertical direction. Despite the flexible connection of the body enabling a movement upwards, the stable support of the body downwards to the vehicle frame is ensured.

Where the “front region” is mentioned here, this refers to the region closest to the top of the vehicle or to the driver's cab. The local details “front”, “rear”, “outside” and “inside” refer in particular to the vehicle moving in the direction of travel with the front of the vehicle in front.

A “flexible connecting element” is preferably understood as meaning any element which is suitable for connecting the vehicle frame to the body and can compensate for movements between the vehicle frame and the body by deformation of the flexible connecting element. Deformation of a structure is understood as meaning the change in the shape of the structure as a result of the action of an external force or mechanical stress. The vehicle frame and the body are accordingly coupled to the flexible connecting element in such a way that forces can be transmitted.

By means of the flexible connecting element, it is possible for the body to become loose, in particular in the event of torsional movements of the vehicle frame, and to move upwards in the vertical direction away from the vehicle frame.

A crucial aspect of the invention is therefore that the body which is connected to the vehicle frame can be at least partially decoupled from the vehicle frame in the connected state without having to release the connection. This gives rise to a body which is mounted movably with respect to the vehicle frame. This reduces the forces acting on the connecting points and increases the durability of the connection between the vehicle frame and body.

In principle, the length of the flexible connecting element determines how far the body can be raised. Preferably, it is provided that raising of the body from the vehicle frame up to 50 mm, preferably up to 25 mm, very particularly preferably up to 10 mm, is ensured by means of the flexible connecting element.

Preferably, two flexible connecting elements are arranged in pairs and axially symmetrically on the vehicle. The axis of symmetry is determined here by the central longitudinal axis of the vehicle.

According to a preferred development of the invention, the body is connected in a rear region of the vehicle frame by means of a rigid connecting element. It has been shown that, in the event of a torsion or twisting, the strongest forces arise at the front connections of the body. In other words: a front corner of the body is always compelled to become loosened from the vehicle frame and to lift off. In the front region, the body is mounted movably relative to the vehicle frame, while in the rear region, the body continues to be rigidly connected to the vehicle frame. It is accordingly possible, for example, in an existing system consisting of a vehicle frame and body, to retrofit the flexible connecting element at the necessary points with just a few and simple conversion measures and thus obtain a high degree of mobility.

According to a preferred development of the invention, the flexible connecting element comprises a deformable material. The flexibility of the connecting element is determined by the choice of the material. Preferably, the flexible connecting element comprises a flexible metal sheet, which changes its shape as a result of the action of external forces. Metals deform elastically at low pressure. This means that the metal atoms leave their place in the lattice structure and return to this place after the pressure is released. The degree of deformability of a metal depends on the density of the lattice structure.

According to a preferred development of the invention, the flexible connecting element comprises a plate. Furthermore preferably, the plate is arranged parallel to the ground or to the road surface in a horizontal plane spanned by the longitudinal and transverse axis of the vehicle. Owing to the horizontal orientation of the plate, the body can be raised in the vertical direction. According to a preferred development of the invention, the plate is arranged perpendicular to the direction of travel or longitudinally to the direction of travel.

According to a preferred development of the invention, the flexible connecting element is arranged between the vehicle frame and the body. In this case, a first part of the connecting element located to the outside of the vehicle frame is connected to the body and a second part of the connecting element located to the inside of the vehicle frame is connected to the vehicle frame.

The flexible connecting element is consequently arranged in such a way that one part of the flexible connecting element is connected to the body and a second part opposite the first part is connected to the vehicle frame. It is important here that the part which is connected to the body is mounted on the outside starting from the vehicle center point, and therefore raising of the outer edge of the body can be ensured. Preferably, it is provided that the part of the flexible connecting element which is connected to the vehicle frame is rigid in order to introduce the forces of the body including load into the frame and thus to support same in a stable manner.

This allows a movement or rotation of the body about the longitudinal axis of the vehicle, and therefore deformations of the vehicle frame caused by unevennesses on different sides of the vehicle can be compensated for. The flexible connecting element allows the body to move upwards, preferably by being able to elastically deform in a kind of S twist or being able to rotate in a horizontal plane.

An S twist is understood here as meaning the shape of the skeleton line of a profile that is positively curved at the front, but slightly bent up again at the end lug. This shape resembles a sine curve and is created by the flexible connection element being raised and simultaneously compressed.

According to a preferred development of the invention, the vehicle frame has at least one open U profile. The flexible connecting element is preferably fastened to the U profile. U profiles are edge parts that have two usually right angles. The flexible connecting element can accordingly be joined particularly simply between the existing U profiles and the edges of the body and integrated in the system.

According to a preferred development of the invention, the body is connected in a central region of the vehicle frame by means of a second flexible connecting element. The central region is arranged between the front and rear regions. In order to avoid excessive stresses in the adjacent region to the rear due to the permitted degree of freedom of the partial decoupling, at least one second flexible connecting element is arranged there. The second connecting element also allows a movement in a vertical direction upwards away from the vehicle frame. Preferably, however, the degree of movement is smaller than the degree of movement of the flexible connecting element in the front region. This gives rise to a transition between the flexible connecting element in the front region and the rigid connecting element in the rear region without a renewed stress arising at the connecting points between the regions.

The second flexible connecting elements are designed here in particular as sheet metal tabs. Sheet metal is a rolled product made of metal, which is supplied as a sheet and the width and length of which are very much greater than its thickness. A tab is the one side of a connection at which two pieces of a flat material are connected.

According to a preferred development of the invention, the body has a plurality of cross members which are connectable to the vehicle frame. The cross members are oriented here in particular perpendicular to the longitudinal axis of the vehicle and can be placed onto the vehicle frame. Preferably, a front cross member is connected to the vehicle frame by means of the flexible connecting element and/or a rear cross member is connected to the vehicle frame by means of a rigid connecting element and/or a middle cross member is connected to the vehicle frame by means of a second flexible connecting element. The cross member which is located closest to the front of the vehicle is movably fastened to the vehicle frame by means of the flexible connecting material, while the cross member which is located furthest away from the front of the vehicle is connected to the vehicle frame by means of the rigid connecting element. In this way, a gradient in respect of the degree of mobility is produced. At the front of the vehicle, the body can at least partially decouple itself and lift off. At the rear of the vehicle, the body is rigidly fastened to the vehicle frame. The middle cross member is connected to the vehicle frame via a second flexible connecting element, in particular via a sheet metal tab. Said sheet metal tab is also elastically deformable in the manner of an S twist.

According to a preferred development of the invention, a flexible connecting element is arranged at each of the outer ends of the transverse strut. The flexible connecting element is therefore arranged on both sides, and therefore the body can be raised on both sides.

The invention will be further explained in detail below using a preferred exemplary embodiment with reference to the drawings.

In the drawings

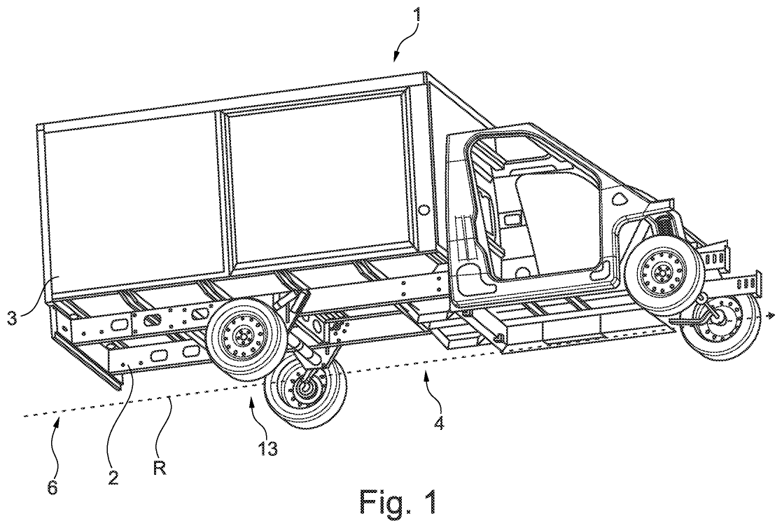

FIG. 1 schematically shows a vehicle according to a preferred exemplary embodiment of the invention in a perspective view,

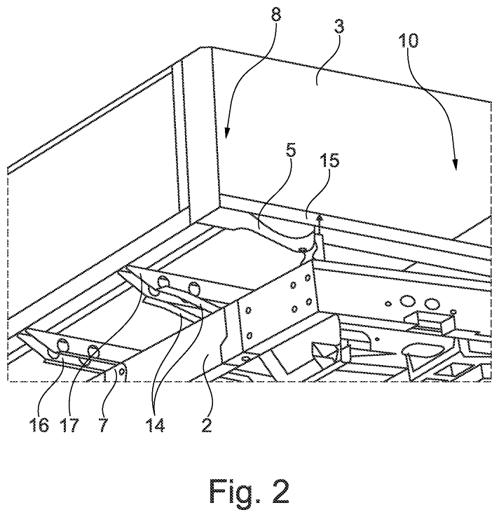

FIG. 2 schematically shows an enlarged region of a tilted vehicle according to a preferred exemplary embodiment of the invention in a perspective view,

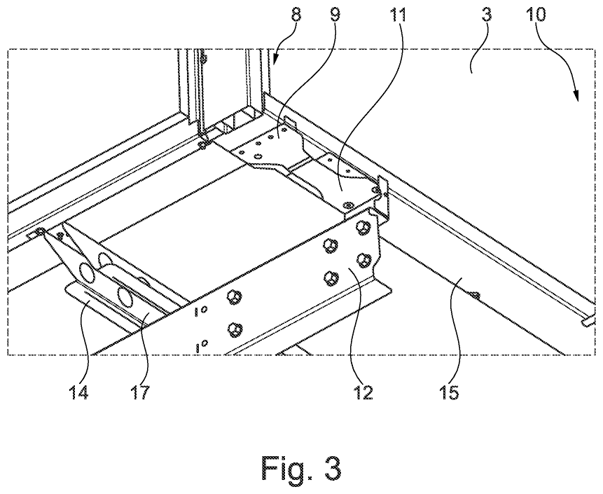

FIG. 3 schematically shows an enlarged region of a straight vehicle according to a preferred exemplary embodiment of the invention in a perspective view,

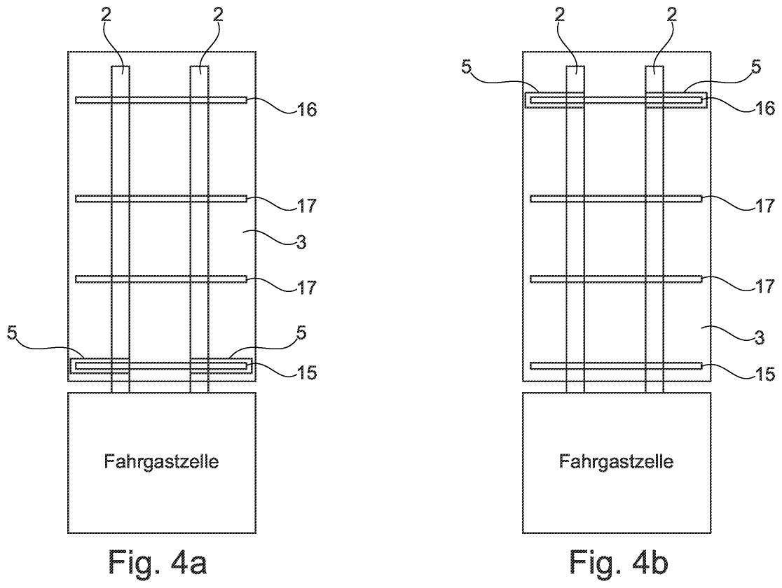

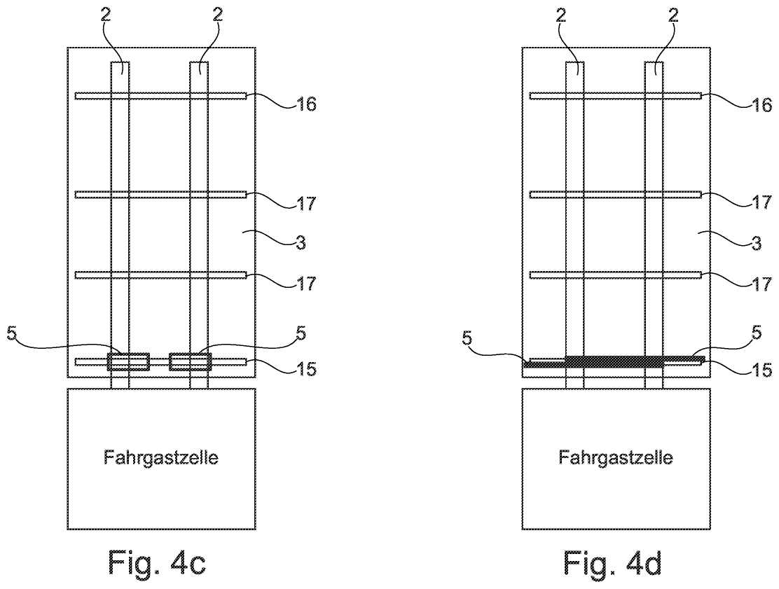

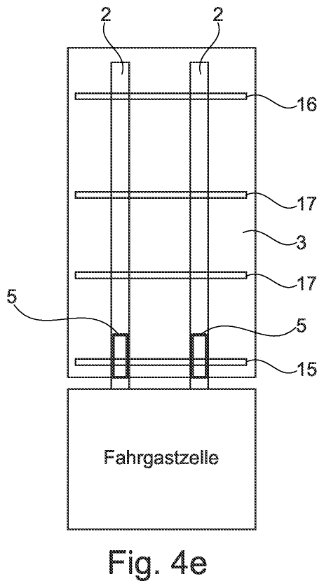

FIGS. 4a-4e schematically show the arrangement of the flexible connecting element according to several preferred exemplary embodiments of the invention in a top view.

FIG. 1 schematically shows a vehicle 1 according to a preferred exemplary embodiment of the invention in a perspective view. The vehicle 1 comprises a vehicle frame 2. A body 3 in the form of a box body is arranged on the vehicle frame 2. The vehicle 1 is divided into a front region 4, a central section 13 and a rear region 6. The local division into “front” and “rear” conforms to the direction of travel R. The body 3 has a plurality of cross members that are fastened on the vehicle frame.

The fastening is shown in an enlarged illustration of the dashed box from FIG. 1 in FIGS. 2 and 3.

FIG. 2 shows a front cross member 15, a middle cross member 17 and a rear cross member 16. The front cross member 15 is connected to the vehicle frame 2 by means of a flexible connecting element 5 in the form of a flexible metal sheet. The flexible connecting element 5 is arranged here on the outside 8 of the front cross member 15. The middle cross member 17 is connected to the vehicle frame 2 via a second flexible connecting element 15 in the form of two flexible sheet metal tabs. The rear cross member 16 is connected to the vehicle frame 2 via a rigid connecting element 7.

The vehicle from FIG. 2 is standing with the right rear wheel on a curb of a height of approx. 160 mm. The front right corner of the body 3 can lift off upwards from the vehicle frame 2 here. This reduces the stress on the bolted connections and remains free from damage. At the same time, support in all other directions, especially downwards, continues to be ensured. In order to avoid excessive stresses in the next connection to the rear to the next cross member 17 due to the permitted degree of freedom of the partial decoupling, flexible connecting elements 14 of a similar form are also formed on said cross member and allow a movement upwards. Both the first flexible connecting element 5 and the second flexible connecting element 14 are elastically deformed and, in the raised state, have a shape in the manner of an S twist.

The lowered state in the case of a vehicle 1 standing on flat ground is shown in FIG. 3. The flexible connecting elements 5, 14 lie flat on the respective cross members 15, 17. The flexible connecting element 5 of the front cross member 15 comprises two parts 9, 11. The first part 9 is located on the outside 8 of the body 3. The opposite second part 10 is located closer to the inside 10. The first part 9 is connected to the body 3, while the second part 11 is connected to the vehicle frame 2. This arrangement allows the body 2 to be raised and slightly rotated about the longitudinal direction of the vehicle. The vehicle frame 2 comprises a strut in the form of an open U profile 12. The second part 11 is arranged on said U profile 12. The arrangement and orientation of the flexible connecting elements 5, 14 ensure that the body 3 can be raised upwards in the vertical direction in a tilted position of the vehicle 1 in order to compensate for the tilted position or resulting torsional forces.

FIGS. 4a to 4e each show a schematic view of the vehicle 1. A top view of a cross section is shown. A body 2 having a plurality of transverse struts 15, 16, 17 is arranged on the frame 2 of the vehicle. The front transverse strut 15 is arranged directly on the passenger cell of the vehicle 1. The rearmost transverse strut 16 is furthest away from the passenger cell on the opposite side. The transverse struts between the front transverse strut 15 and the rear transverse strut 16 are the middle transverse struts 17. The flexible connecting element 5 is arranged in each case in pairs on a transverse strut. The arrangement is axially symmetrical here with respect to the central longitudinal axis of the vehicle.

In FIG. 4a, the flexible connecting elements 5 are arranged on the frontmost transverse strut 15. The flexible connecting elements 5 are arranged transversely to the direction of travel and directed outwards from the transverse struts 15, i.e. towards the outside of the vehicle 1. In FIG. 4b, the flexible connecting elements 5 are arranged in the same manner, but the flexible connecting elements 5 are connected to the rearmost transverse strut 16. The flexible connecting elements 5 can also be arranged directed inwards, i.e to the inside of the vehicle 1. This inwardly directed arrangement is shown in FIG. 4c.

In FIG. 4d, the flexible connecting elements 5 are also arranged directed inwards. However, the length of the flexible connecting elements 5 is greater than the distance between the members of the frame, and therefore a flexible connecting element 5 extends beyond the adjacent member and is preferably connected to the body 2 on the opposite outer side of the body 2.

Alternatively, the flexible connecting elements 5 can be aligned in or counter to the direction of travel. This arrangement is shown in FIG. 4e. Depending on whether the flexible connecting elements 5 are arranged in or counter to the direction of travel, they permit opening or raising of the body 2 to the front or to the rear.

In addition, any intermediate positions between the positions shown in FIG. 4a to FIG. 4e are also covered by the invention.

### LIST OF REFERENCE SIGNS

1 Vehicle
2 Vehicle frame
3 Body
4 Front region
5 Flexible connecting element
6 Rcar region
7 Rigid connecting element
8 Outside
9 First part
10 Inside
11 Second part
12 U profile
13 Central region
14 Second flexible connecting element
15 Front cross member
16 Rear cross member
17 Middle cross member
R Direction of travel

1. Vehicle comprising a vehicle frame and a body arranged on the vehicle frame, wherein
the body is connected in a front region of the vehicle frame to the vehicle frame by means of at least one flexible connecting element, and
the flexible connecting element is designed to ensure a movement of the body away from the vehicle frame in the vertical direction.

2. Vehicle according to claim 1, wherein the body is connected in a rear region of the vehicle frame by means of a rigid connecting element.

3. Vehicle according to claim 1, wherein the flexible connecting element comprises a deformable material.

4. Vehicle according to claim 1, wherein the flexible connecting element comprises a plate and the plate is arranged in a horizontal plane.

5. Vehicle according to claim 4, wherein the longitudinal direction of the plate is oriented perpendicular to the direction of travel or longitudinally to the direction of travel.

6. Vehicle according to claim 1, wherein the flexible connecting element is arranged between the vehicle frame and the body, a first part of the flexible connecting element located to the outside of the vehicle frame is connected to the body and a second part of the flexible connecting element located to the inside of the vehicle frame is connected to the vehicle frame.

7. Vehicle according to claim 1, wherein the vehicle frame has at least one U profile and the flexible connecting element is fastened to the U profile.

8. Vehicle according to claim 1, wherein the body is connected in a central region of the vehicle frame by means of a second flexible connecting element.

9. Vehicle according to claim 1, wherein the body has a plurality of cross members which are connectable to the vehicle frame, a front cross member is connected to the vehicle frame by means of the flexible connecting element and/or a rear cross member is connected to the vehicle frame by means of a rigid connecting element and/or a middle cross member is connected to the vehicle frame by means of a second flexible connecting element.

10. Vehicle according to claim 1, wherein a flexible connecting element is arranged at each of the outer ends of the respective transverse strut.
